(19) United States
(12) Patent Application Publication
(10) Pub. No.: US 2013/0014139 A1
(43) Pub. Date: Jan. 10, 2013

(54) IMAGE DISPLAY SYSTEM, IMAGE DISPLAY METHOD, IMAGE DISPLAY CONTROL PROGRAM AND TRANSMISSION PROGRAM FOR MOTION INFORMATION

(75) Inventors: Nobuo KAWAKAMI, Tokyo (JP); Yasuyuki SUGITANI, Tokyo (JP); Daisuke ENOMOTO, Tokyo (JP)

(73) Assignee: DWANGO CO., LTD., Tokyo (JP)

(21) Appl. No.: 13/543,165

(22) Filed: Jul. 6, 2012

(30) Foreign Application Priority Data
Jul. 8, 2011 (JP) 2011-152318

(51) Int. Cl. H04H 60/33

(52) U.S. Cl. 725/9

(57) ABSTRACT

In the conventional system, although a viewer can feel only part of the atmosphere of the hall while viewing images of a live performance etc, the viewer cannot enhance the mood and cannot get a feeling of participating in the live event. An image display system of the present invention is a system for displaying an image reflecting a motion of a viewer outside a hall for live performance etc. on a display being installed in the hall. Specifically, the system simultaneously transmits the image of the live performance etc. in the hall to a terminal for viewing of the viewer, receives motion information indicating the motion of the viewer outside the hall, thereby controlling display of the image on the display on the basis of the motion information.

### BACKGROUND OF THE INVENTION

1. Field of the Invention

The present invention relates to image display system, image display method, image control program and transmission program for motion information.

2. Description of the Related Art

In general, an image of a live performance etc. is simultaneously transmitted from the hall of the live performance etc. to a terminal for viewing outside the hall.

The viewer outside the hall can feel a part of the atmosphere of the hall while viewing images of the live performance etc.

Moreover, in Japanese Unexamined Patent Application Publication No. 2011-103522, a system, where it is determined whether the artist designated through the user's terminal is performing, and an image of the live performance etc. is distributed to the user's terminal in response to a request for viewing, is disclosed. In Japanese Unexamined Patent Application Publication No. 2008-244869, a real-time distribution system, where image data, which can be divided into blocks at suitable points for cut edit, are appropriately combined according to the status of distribution of the images, a program is edited, and the edited program is distributed to the viewer, is disclosed.

### RELATED ART DOCUMENTS

Patent Document 1: Japanese Unexamined Patent Application Publication No. 2011-103522

Patent Document 2: Japanese Unexamined Patent Application Publication No. 2008-244869

In the above conventional system, although the viewer can feel only part of the atmosphere of the hall while viewing images of the live performance etc, the viewer cannot enhance the mood and cannot get a feel for participation in the live event.

### SUMMARY OF THE INVENTION

In order to solve the above deficiencies, we provide an image display system for displaying an image reflecting a motion of a viewer outside a hall for live performance etc. on a display having been installed in the hall that comprises a live transmitter, simultaneously transmitting the image of the live performance etc. in the hall to a terminal for viewing of the viewer; a motion detector, detecting the motion of the viewer outside the hall; a transmitter for motion information, transmitting motion information for indicating the motion detected by the motion detector; a receiver for motion information, receiving the motion information transmitted by the transmitter for motion information; and a display controller, controlling display of the image on the display having been installed in the hall on a basis of the received notion information.

According to the present invention having the above configuration, the viewer outside the hall can enhance the mood by his own motion, like an audience member in the hall, while viewing the image of the live performance by his terminal for viewing, so that the viewer can get a feeling of participating in the live event even while outside the hall.

### BRIEF DESCRIPTION OF THE DRAWINGS

FIG. 1 is a functional block diagram of an image display system of a first embodiment.

FIG. 2 is a perspective view exemplifying a hall with displays on an entire wall.

FIG. 3 is an illustration showing a scene of FIG. 2 viewed from an audience.

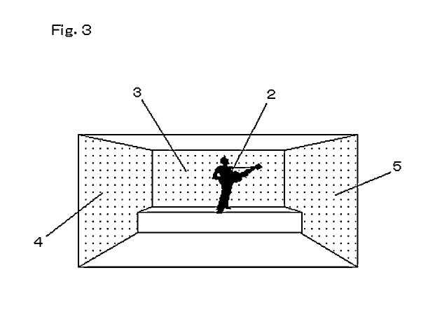

FIG. 4 is an illustration showing a scene of FIG. 2 viewed from a performer.

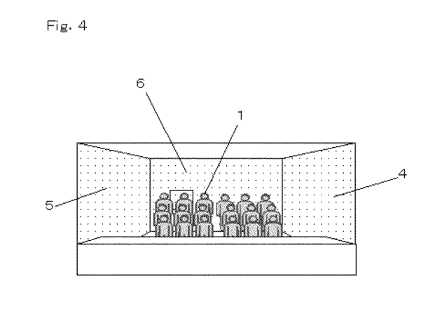

FIG. 5 is an illustration showing display of an image of fireworks on displays in the hall

FIG. 6 is a diagram exemplifying a table where detail of motion information and detail of display control are correlated.

FIG. 7 is an illustration showing display of avatars of viewers on displays in the hall.

FIG. 8 is a diagram exemplifying a concrete configuration of the image display system of the first embodiment.

FIG. 9 is a flowchart of an image display method of the first embodiment.

FIG. 10 is a functional block diagram of an image display system of a second embodiment.

FIG. 11 is an illustration showing display of concert lights on displays in the hall.

FIG. 12 is a functional block diagram of an image display system of a third embodiment.

FIG. 13 is a diagram exemplifying a table where each viewer ID and display time information of an image reflecting the viewer's motion are correlated.

FIG. 14 is a flowchart of the case where a display request from the viewer is received.

FIG. 15 is a flowchart of an image display method of the third embodiment.

FIG. 16 is a functional block diagram of an image display system of a fourth embodiment.

FIG. 17 is a flowchart of an image display method of the fourth embodiment.

FIG. 18 is a functional block diagram of an image display system of a fifth embodiment.

FIG. 19 is a flowchart of the case where an extension request from the viewer is accepted.

FIG. 20 a flowchart of an image display method of the fifth embodiment.

### DESCRIPTION OF THE PREFERRED EMBODIMENTS

Embodiments of the present invention will be described hereinafter. Relationships between the embodiments and claims are as follows. The first embodiment will mainly describe claims 1, 3, 9, 10 and 11. The second embodiment will mainly describe claims 2, 4, and 5. The third embodiment will mainly describe claim 6. The fourth embodiment will mainly describe claim 7. The fifth embodiment will mainly describe claim 8. The present invention is not to be limited to the above embodiments and able to be embodied in various forms without departing from the scope thereof

### First Embodiment

### Outline of First Embodiment

An image display system of a first embodiment is an image display system for displaying an image reflecting a motion of a viewer outside a hall of live performance etc. on a display having been installed in the hall. Specifically, the system simultaneously transmits the image of the live performance etc. in the hall to a terminal for viewing of the viewer, receives motion information indicating the motion of the viewer outside the hall, thereby controlling display of the image on the display on the basis of the motion information.

### Configuration of First Embodiment

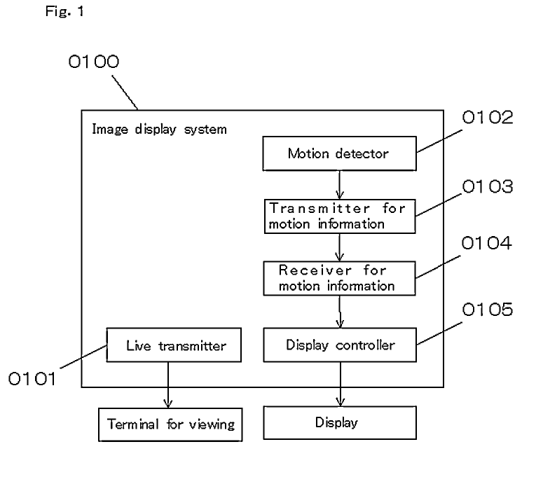

FIG. 1 is a functional block diagram of an image display system of the first embodiment. As shown in FIG. 1, an ‘image display system’ 0100 comprises a ‘live transmitter’ 0101, a ‘motion detector’ 0102, a ‘transmitter for motion information’ 0103, a ‘receiver for motion information’ 0104, and a ‘display controller’ 0105. Here, the motion detector or the transmitter for motion information may not be a single unit, and a plurality of units may be used according to the viewer or the number of terminals for viewing. Hereinafter, descriptions of the respective components will be provided.

The image display system displays an image reflecting a motion of a viewer outside a hall for live performance etc. on a display having been installed in the hall. The live performance means a performance in front of an audience such as theater, sports, stand-up comedy, comedy skit, movie, TV show, Kabuki, Rakugo, magic, and street performance, in addition to the live performance. The hall means a place, which can accommodate an audience, such as a concert hall, a park, a studio, a baseball stadium, a football stadium, an athletics stadium, an exhibition hall, a movie theater, Kabuki-za Theater, and a community hall.

The display may be any device capable of displaying inputted images, and the shape and size thereof are not limited. For example, a large display of several meters to several tens of meters for a large place such as a concert hall, a baseball stadium or football stadium is assumed. Moreover, examples of an installation site for the display include a place for performance such as a stage and seats. Moreover, the display may be placed on the wall, floor or ceiling etc, and the display may be used for a partition of the hall.

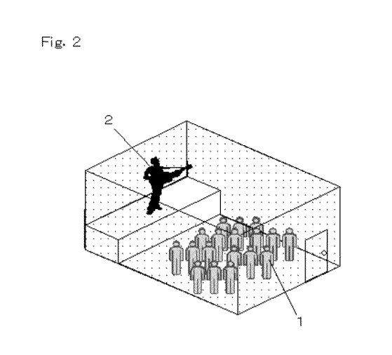

FIG. 2, 3, or 4 shows perspective view exemplifying a hall with displays on an entire wall, and respectively shows the perspective view of the hall, a scene viewed from the ‘audience in the hall’ 1, or a scene viewed from the ‘performer’ 2. In this case, the ‘background of the stage’ 3, the ‘right and left walls of the floor’ 4 and 5, and the ‘wall including the entrance of the floor’ 6 are respectively used for the display. In this case, the performer and the audience in the hall are surrounded by the display. Moreover, the ceiling and floor may be used for the display. As described above, the entire wall of the hall is used for the display, so that the audience in the hall feels as if they are in a virtual space.

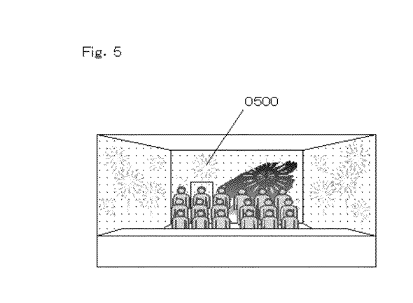

The viewer outside the hall means one or more viewers located near the terminal for viewing which is capable of receiving and displaying the image of the live performance etc. Here, the location of the terminal for viewing is not limited, and any location, including a foreign country, where the image of the live performance etc. can be received, is suitable. Moreover, the display of image reflecting the motion of the viewer outside the hall for live performance etc, means the details of the image to be displayed is determined according to the details of the motion of the viewer outside the hall. For example, when the one or more viewers raise their hands, as shown in FIG. 5, ‘image display element showing fireworks’ 0500 is displayed on the display in the hall.

The ‘live transmitter’ has a function of simultaneously transmitting the image of the live performance etc. in the hall to a terminal for viewing of the viewer. Here, in addition to the general TV device examples of the terminal for viewing of the viewer outside the hall, having functions of receiving and displaying an image, include a personal computer, a mobile phone, a portable game machine, and a portable terminal such as a PDA. Examples of the location site for such terminal for viewing include a commercial facility outside the hall, and a public space, in addition to the residence of the viewer. Moreover, although a plurality of viewers outside the hall generally exists, the viewer outside the hall may be alone.

Moreover, the simultaneous transmitting of the image of the live performance etc. in the hall means transmission of the image of the performance in the hall in real time or at a timing near real time (a time-lag from several seconds to several minutes is allowable). Moreover, the transmission (distribution) to the terminal for viewing may be executed through wired or wireless communication or through a predetermined server on the network.

The ‘motion detector’ has a function of detecting the motion of the viewer outside the hall. The motion of the viewer means viewer's motion of a part or an entire body. For example, the viewer's motion mainly includes motions of a hand, an arm, a leg, a hip, a face, a finger, an eye, and a mouth. Moreover, when the viewer wears a hat or a wrist band, or holds a megaphone, a handy fan, a flag, a penlight, or a mobile phone, the viewer's motions concerning these objects are included as the viewer's motion. For example, the viewer's motion of taking his hat off, or of waving the megaphone, handy fan or flag are detected.

The motion detector may detect the viewer's motion in contact, or without contact with the viewer. An example of the detector detecting the motion in contact with the viewer includes a small terminal equipped with a speed sensor and an acceleration sensor. The small terminal may emit light like a light emitter (concert light), which an audience in a concert etc. holds or wears. Moreover, it is possible to control the light emitter so as to emit only within a predetermined time. For example, display time information of the image reflecting the viewer's motion is acquired, thereby controlling the light emitter so as to emit light only within the display time. Moreover, even within the display time, it is possible to control the light emitter such that an emission intensity is reduced as the remaining time decreases Descriptions of management of the display time information will be provided in the after-mentioned third to fifth embodiments.

Note that a computer peripheral device such as a mouse or a tablet device also detects motion of a hand or a finger, and is included in the motion detector. An example of the detector detecting the motion without contact with the viewer includes a stationary terminal equipped with a light-receiving sensor such as an optical sensor or an infrared sensor. Although the stationary terminal does not make the same motion as that of the viewer, the terminal can receive light from the viewer or the object held by the viewer. Moreover, the motion detector may detect motions of a plurality of viewers. For example, when detecting the viewer's motions on the basis of light signal from the viewers etc, the area of the respective viewers is specified within a screen to be detected, thereby detecting the motion of the respective viewers.

The ‘transmitter for motion information’ has a function of transmitting motion information for indicating the motion detected by the motion detector. Here, the motion information of the viewer may be information of the motion detected by the motion detector, or may be abstracted information of the detected motion. Examples of the motion information for indicating the detected motion include raw data of displacement, speed, and acceleration in motion. Moreover, an example of the abstracted information of the detected motion includes information of detail of motion extracted on the basis of the raw data of the motion.

For example, the transmitter for motion information may store information of a plurality of segments regarding direction of motion, distance of motion, motion speed, and motion acceleration etc, may determine belongingness of the respective parameters, indicated by the detection signal from the motion detector, to the segments, and may transmit the information of segment ID of the respective parameters as the motion information. Moreover, the transmitter for motion information may store information of the detail of motion categorized into a plurality of categories (e.g., motion of raising both hands, motion of raising right hand, or motion of raising left hand), may determine belongingness of the viewer's motion to the categories on the basis of the detection signal from the motion detector, and may transmit the information of category ID as the motion information.

Moreover, when one motion detector detects motions of a plurality of viewers, the motion information of the respective viewers may be generated and transmitted, or the motion information may be generated on the basis of a combination of motions of the respective viewers and transmitted. Examples of the combination of motions of the respective viewers include motions of a plurality of viewers with their arms around each other, holding hands, and doing hi-five. The details of the motions may be extracted by specifying the area of the respective viewers and by tracking coordinates of parts of the body of the respective viewers according to an image analysis program.

Moreover, the motion detector and/or the transmitter for motion information has ID for being discriminated from other motion detector or the transmitter for motion information, thereby enabling transmission of the motion information with the ID as a viewer ID. Moreover, the motion detector and the transmitter for motion information may be mutually connected as a separate apparatus through wired or wireless LAN, or may be mutually connected as an integrated apparatus through a system bus. For example, a configuration, where the motion detector informs the transmitter for motion information of the detection signal of the viewer's motion through an infrared interface, or a configuration, where the signal is informed as a system signal to the transmitter for motion information, may be used. Here, when a plurality of viewers outside the hall as objects of motion detection exist, the transmitter for motion information of the respective viewers may constantly transmit the motion information, or may acquire the information of time slot allocated to the respective viewers, thereby transmitting the motion information only in the time slot (a detailed description will be provided in the fourth embodiment).

Moreover, the motion detector may comprise a sound detection section for detecting sound from the viewer and sound created by the viewer's motion, and the transmitter for motion information may transmit sound information as the motion information. Moreover, the detail of the viewer's motion may be extracted on the basis of sound signal generated by the sound detection section. For example, when sounds of a specific frequency band generated upon clapping hands are continuously detected, it is determined that the viewer claps his hands, thereby generating the motion information, or when sounds of a specific timing of rhythm, it is determined that the viewer moves in the rhythm, thereby generating the motion information. Moreover, the motion detector may comprise sound recognition section, and may analyze the detection signal from the sound detection section, and when sound of a specific word or sentence is recognized, it is determined that the viewer calls out a specific word, thereby generating the motion information.

The ‘receiver for motion information’ has a function of receiving the motion information transmitted by the transmitter for motion information. Here, the motion information transmitted from the transmitter for motion information may be directly received, or may be received through the Internet etc. When a plurality of viewers outside the hall as objects of motion detection exist, the motion information may be simultaneously received from the respective transmitters for motion information of the viewers, or the respective motion information may be received with respect to each time slot allocated to the respective viewers according to a predetermined time schedule (a detailed description will be provided in the fourth embodiment).

Here, the motion information to be received may be used as marketing information in addition to the after-mentioned use by the display controller. For example, in a live performance etc, it is possible to extract the detail of motion of the viewer outside the hall for a specific performer or at a specific song and words. The receiver for motion information preliminarily comprises a storage for ID information of the respective performers and songs etc. (storage section for live information), and generates a table information for correlating the respective IDs and the motion information to be received, thereby enabling this extraction. This table information may be used for determining, for example, the excitement of the viewer while watching a specific performer or listening to a specific song.

The ‘display controller’ has a function of controlling display of the image on the display having been installed in the hall on a basis of the received notion information. The controlling display of the image on the display on a basis of the received notion information means control of displaying the image reflecting the viewer's motion on the display. In the method for controlling display, a table, where detail of motion information and detail of display control are correlated, is stored, thereby determining the detail of the display control on the basis of the received motion information and the stored table.

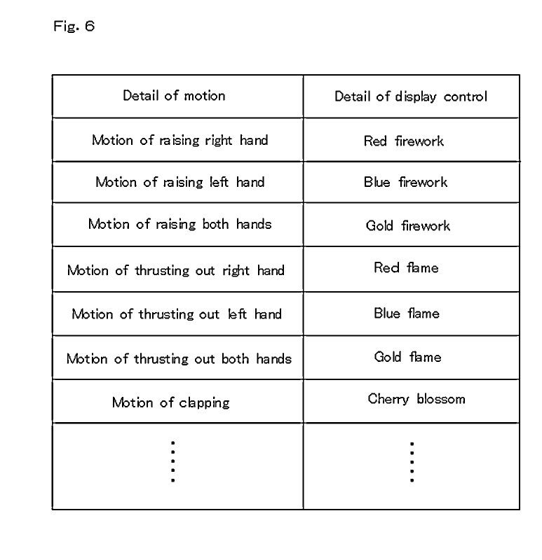

FIG. 6 is a diagram exemplifying a table where detail of motion information and detail of display control are correlated. In FIG. 6, when the viewer raises right hand, left hand, or both hands, the image showing red, blue, or gold firework is displayed, when the viewer thrusts out right hand, left hand, or both hands, the image showing red, blue, or gold flame is displayed for a predetermined time period, and when the viewer claps his hands, the image of cherry blossoms is displayed. Moreover, it is possible to display different images according to more concrete the viewer's motion such as speed, acceleration, and angle of raising hands, or to display different images according to combinations of motions within a predetermined time. In the above example, the details of the display control is determined on the basis of the table, and it is further possible to determine an image to be displayed on the basis of formula having values such as speed and acceleration of the viewer's motion as parameters.

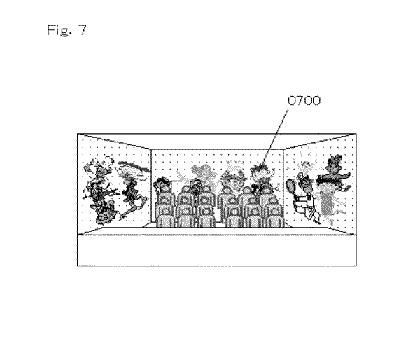

Moreover, the display controller may comprise a ‘display section for avatar’. The ‘display section for avatar’ has a function of controlling display of an image including an avatar on a basis of the motion information. Here, the avatar is a display element as a representation of the user. The detail thereof is not limited and any avatar, which the user can recognize his avatar, may be used. For example, as shown in FIG. 7, an avatar in the motif of an animal, an insect, a reptile, and a plant, or an avatar in the motif of a character in a comic or an animation may be used. Moreover, the display element of the avatar may be generated by a combination of the viewer's photos etc. Moreover, the avatar may not accurately reproduce the viewer's motion, and any avatar making motion associated with the viewer's motion may be used. For example, when the viewer moves swinging his body, the avatar of a flower swinging by reflecting the viewer's motion is displayed.

In a determination as to what avatar is displayed for the viewer, the information designating an avatar ID may be included upon transmitting the motion information by the transmitter for motion information, thereby determining the avatar to be displayed on the basis of the designated avatar ID. Moreover, information of attribute of the viewer (e.g., gender, height, weight, each size of body part, age, hobby, and occupation) may be acquired along with the motion information through the receiver for motion information, thereby determining the avatar to be displayed on the basis of the attribute information. The display controller may store a plurality of avatars having different appearances correlated with the avatar's ID as the image element information of avatar, or may store program information for generating an avatar, whose appearance changes according to the attribute value (e.g., height or weight). Moreover, when the information of the display element of avatar can be acquired from the transmitter for motion information through the receiver for motion information, the information may be used without change.

Moreover, position of displaying the display element reflecting the viewer's motion on the display screen may be determined on the basis of an order of receiving the motion information, or on the basis of the viewer's attribute information. For example, the display element may be displayed near the center of the display screen in order of receiving the motion information.

### Concrete Configuration of First Embodiment

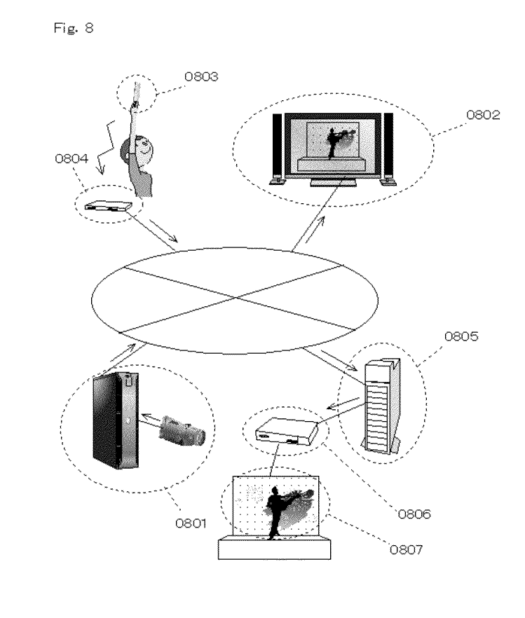

FIG. 8 is a diagram exemplifying a concrete configuration of the ‘image display system’ of the first embodiment. In FIG. 8, a ‘live transmitter’ 0801 is configured by a CPU, a RAM, a ROM, a long-term memory (including nonvolatile memory, and the same applies hereinafter), a camera device, and a WAN interface etc, and transmits image signal from the camera device to ‘terminal for viewing’ 0802, which has requested for viewing. Note that the respective hardware such as the CPU, RAM, and ROM are mutually connected through a system bus, and exchange signals (the same applies hereinafter). The ‘terminal for viewing’ 0802 is configured by a CPU, a RAM, a GPU, a graphic memory, a ROM, a long-term memory, a WAN interface etc, and a display, and receives the image of live performance etc. transmitted from the ‘live transmitter’ 0801 through the WAN interface, and displays the image.

The ‘motion detector’ 0803 is configured by a CPU, a RAM, a ROM, a flash memory, an infrared interface, a sensor interface, and a sensor etc, and transmits the motion signal of the viewer acquired though the sensor interface to a ‘transmitter for motion information’ 0804 through the infrared interface. Moreover, the ‘transmitter for motion information’ 0804 is configured by a CPU, a RAM, a ROM, a long-term memory, an infrared interface, a WAN interface etc, and generates the motion information on the basis of the motion signal received through the infrared interface, and transmits the generated motion information to a ‘receiver for motion information’ 0805 through the WAN interface.

The ‘receiver for motion information’ 0805 is configured by a CPU, a RAM, a ROM, a long-term memory, a WAN interface, and a LAN interface etc, and receives the motion information through the WAN interface, and transmits the motion information to a ‘display controller’ 0806 through the LAN interface. The ‘display controller’ 0806 is configured by a CPU, a RAM, a ROM, a long-term memory, and a LAN interface etc, and receives the motion information through the LAN interface, and generates the display control information for a large-screen display on the basis of the motion information, and transmits the generated display control information for a large-screen display' 0807. The large-screen display' 0807 displays the image on the basis of the received display control information.

### Processing Flow of First Embodiment

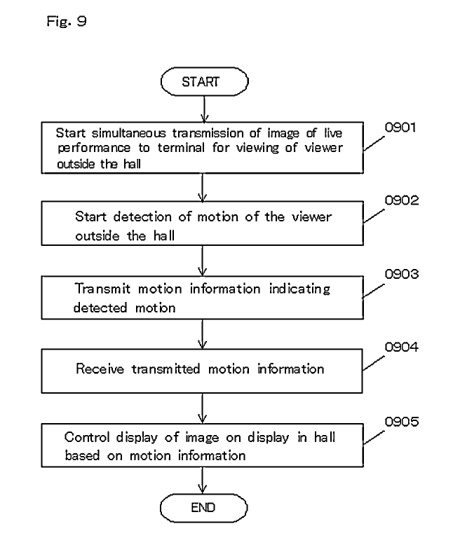

FIG. 9 is a flowchart of an image display method executed in the image display system of the first embodiment. At the outset, in a step S0901, the live transmitter starts simultaneous transmission of image of live performance to the terminal for viewing of viewer outside the hall in response to a request for viewing from the terminal for viewing (step of starting simultaneous transmission). The terminal for viewing receives and displays the image of live performance from the live transmitter. Subsequently, in a step S0902, the motion detector starts detection of motion of the viewer outside the hall (step of starting detection of motion). The motion detected by the motion detector is, for example, transmitted to the user's communication terminal through the wireless interface. Subsequently, in a step S0903, the user's communication terminal transmits the motion information indicating the detected motion (step of transmitting motion information). Subsequently, in a step S0904, the control-side communication terminal receives the transmitted viewer's motion information (step of receiving motion information). The motion information received by the control-side communication terminal is, for example, transmitted to a display control terminal through the LAN interface. Subsequently, in a step S0905, the display control terminal controls display of the image on the display in hall based on the received motion information (step of controlling display).

### Effects of First Embodiment

According to the image display system of the first embodiment, the viewer outside the hall can enhance the mood by his own motion like an audience in the hall while viewing the image of the live performance by his terminal for viewing, so that the viewer can get a feeling of participating in the live event even outside the hall.

### Second Embodiment

### Outline of Second Embodiment

An image display system of a second embodiment is basically the same as that of the first embodiment, and further has a feature in detecting swinging motion of a hand or arm of the viewer outside the hall, thereby displaying an image reflecting the swinging motion of the hand or arm of the viewer on the display in the hall for live performance.

### Configuration of Second Embodiment

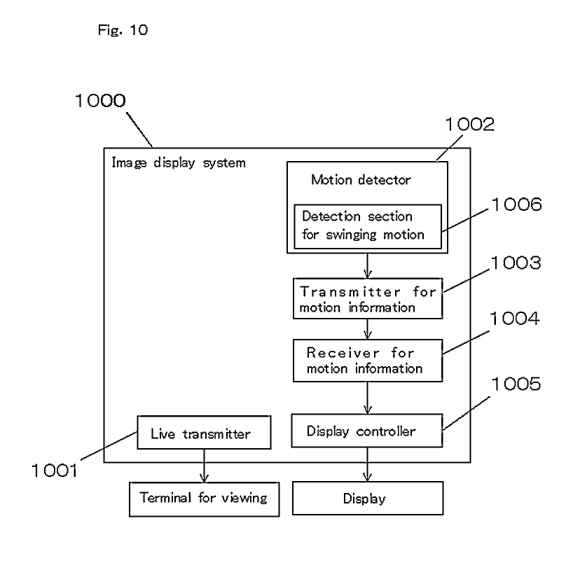

FIG. 10 is a functional block diagram of an image display system of the second embodiment. As shown in FIG. 10, an ‘image display system’ 1000 comprises a ‘live transmitter’ 1001, a ‘motion detector’ 1002, a ‘transmitter for motion information’ 1003, a ‘receiver for motion information’ 1004, and a ‘display controller’ 1005. The motion detector further comprises a ‘detection section for swinging motion’ 1006. Hereinafter, a description of the detection section for swinging motion will be provided.

The ‘detection section for swinging motion’ has a function of detecting swinging motion of the viewer outside the hall. Examples of the swinging motion of the viewer include swinging motions of a head, a hip, a leg, and an entire body back and forth and around in addition to the swinging motion of hand and arm back and forth and around. Although the viewer sometimes makes a motion unrelated to the live performance when viewing the live performance, the swinging motion is generally made by an audience in the hall for the live performance, and possibly has relation to the live performance. Accordingly, it is important in reflecting the viewer's motion on the display in the hall to selectively detect the swinging motion of the viewer.

The detection section for swinging motion is for detecting the above swinging motion. The detection section for swinging motion may detect the viewer's swinging motion in contact or without contact with the viewer. An example of the detector detecting the motion in contact with the viewer includes a small terminal equipped with a vibration sensor, which the viewer holds in his hand, or wears it on a part of his body. Note that a computer peripheral device such as a mouse or a tablet device also detects the swinging motion of a hand in a horizontal direction, and is included in the detection section for swinging motion. An example of the detection section detecting the swinging motion without contact with the viewer includes a stationary terminal equipped with a light-receiving sensor such as an optical sensor or an infrared sensor. The stationary terminal can receive light from the viewer or the object, which the viewer is wearing, thereby detecting the swinging motion.

The transmitter for motion information transmits the swinging motion information for indicating the swinging motion detected by the detection section for swinging motion. Examples of the swinging motion include values of distance, direction, and cycle of the viewer's swinging motion. Moreover, it is possible to preliminarily provide a plurality of segments for the distance, direction, and cycle of the viewer's swinging motion, to determine the belongingness of the respective parameters of the swinging motion to the segments on the basis of the detection signal of the swinging motion, and to transmit the information of segment ID of the respective parameters as the swinging motion information. Moreover, it is possible to categorize the details of swinging motion into a plurality of categories (e.g., swinging distance is small, medium, or large, swinging object is right hand, left hand, or both hands, and swinging cycle is long, normal, or short), to determine belongingness of the viewer's motion to the categories on the basis of the detection signal, and to transmit the information of category ID as the motion information.

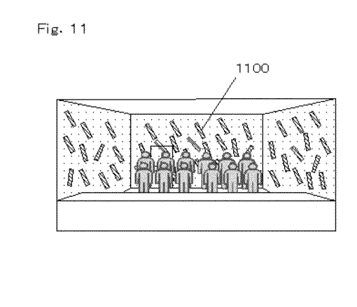

Moreover, the display controller may comprise a ‘display section for swinging motion’. The ‘display section for swinging motion’ has a function of controlling display of an image including a swinging object showing the same motion as the swinging motion of the viewer. The swinging object is an object which swings. As shown in FIG. 11, examples of the swinging object include a ‘concert light’ 1100, a light emitter, which the viewer holds in his hand, or wears on a part of his body, an object in the motif of a human hand or arm, and an object in the motif of a plant with a stem.

Moreover, the ‘swinging object showing the same motion as the swinging motion of the viewer’ may not accurately reproduce the viewer's swinging motion, and any object making swinging motion associated with the viewer's swinging motion may be used. For example, when the viewer moves swinging his body, a flower as the swinging object swinging by reflecting the viewer's motion is displayed. The display section for swinging motion controls display of the swinging object on the display, such that the motion information such as the distance, direction, and cycle of the viewer's swinging motion are reflected on the motion of the swinging object.

In a determination as to what swinging object is displayed for the viewer, the information designating a swinging object ID may be included upon transmitting the motion information (swinging motion information) by the transmitter for motion information, thereby determining the swinging object to be displayed on the basis of the designated swinging object ID. In this case, the display controller may store the swinging objects having different appearances correlated with the swinging object ID as the image element information of swinging object. Moreover, when the information of the display element of the swinging object can be acquired from the transmitter for motion information through the receiver for motion information, the information may be used without change.

### Processing Flow of Second Embodiment

A flowchart of an image display method executed in the image display system of the second embodiment is the same as that of FIG. 9. At the outset, the live transmitter starts simultaneous transmission of image of live performance to the terminal for viewing of viewer outside the hall in response to a request for viewing from the terminal for viewing (step of starting starts simultaneous transmission). The terminal for viewing receives and displays the image of live performance from the live transmitter. Subsequently, the motion detector starts detection of swinging motion of the viewer outside the hall (step of starting detection of motion). The motion detected by the motion detector is, for example, transmitted to the user's communication terminal through the wireless interface. Subsequently, the user's communication terminal transmits the swinging motion information indicating the detected swinging motion (step of transmitting swinging motion information). Subsequently, the control-side communication terminal receives the transmitted viewer's swinging motion information (step of receiving swinging motion information). The swinging motion information received by the control-side communication terminal is, for example, transmitted to a display control terminal through the LAN interface. Subsequently, the display control terminal controls display of the image on the display in hall based on the received swinging motion information (step of controlling display).

### Effects of Second Embodiment

According to the image display system of the second embodiment, the viewer outside the hall can enhance the mood by his own swinging motion like an audience member in the hall, waving the light emitter, while viewing the image of the live performance by his terminal for viewing.

### Third Embodiment

### Outline of Third Embodiment

An image display system of a third embodiment is basically the same as that of the first embodiment, and further has a feature in managing display time information of the image reflecting the motion of the viewer, and in controlling display of the image reflecting the motion of the viewer during the display time.

### Configuration of Third Embodiment

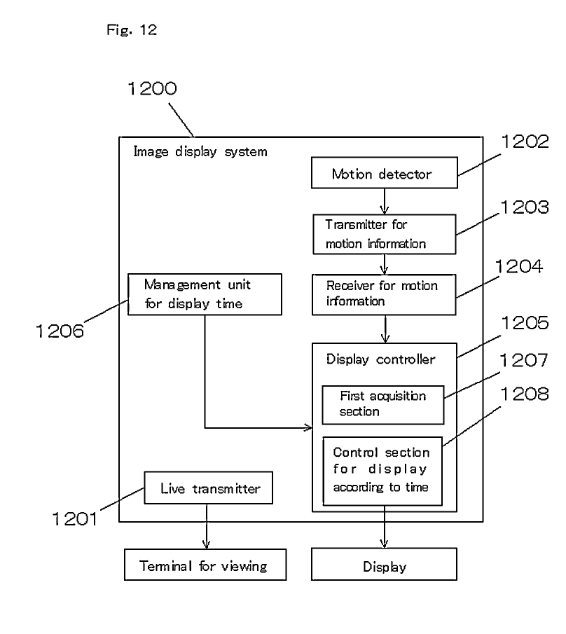

FIG. 12 is a functional block diagram of an image display system of the third embodiment. As shown in FIG. 12, an ‘image display system’ 1200 comprises a ‘live transmitter’ 1201, a ‘motion detector’ 1202, a ‘transmitter for motion information’ 1203, a ‘receiver for motion information’ 1204, a ‘display controller’ 1205, and a ‘management unit for display time’ 1206. The display controller further comprises a ‘first acquisition section’ 1207, and a ‘control section for display according to time’ 1208. Hereinafter, descriptions of the ‘first acquisition section’, and the ‘control section for display according to time’ will be provided.

The ‘management unit for display time’ has a function of managing display time information of the image reflecting the motion of the viewer. The display time includes a timing of starting display, a timing of ending display, and a duration of display etc. The timing of starting display may be determined by time for starting display, or on the basis of elapsed time from starting of the live performance etc.

In the management of display time, a table, where the image reflecting the motion of the respective viewers and the display time for the viewer are correlated, is stored and updated, and the display time for the image reflecting the motion of the respective viewers is determined on the basis of the attribute information of the respective viewers. Thus, the respective display time for the viewer is managed, thereby appropriately displaying the display element reflecting the motion of the respective viewers without jamming them into the display screen even when a plurality of viewers outside the hall exists.

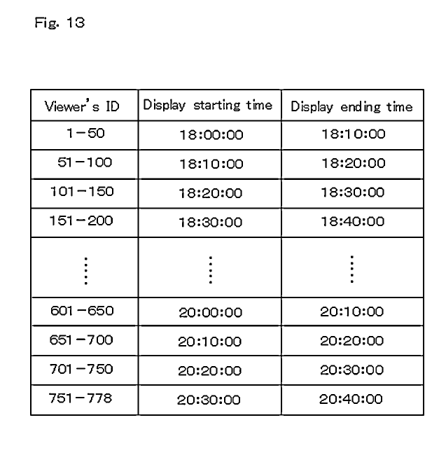

FIG. 13 is a diagram exemplifying a table where each viewer ID and display time information of an image reflecting the viewer's motion are correlated. In this table of FIG. 13, a predetermined display time slot is allocated with respect to each predetermined number of viewers. For example, the time slot from 18:00 to 18:10 is allocated to the viewers from first to fiftieth, and the time slot from 18:10 to 18:20 is allocated to the viewers from fifty-first to one-hundredth.

In the above example of FIG. 13, the viewer ID is allocated in the order of display time slots, and it is not limited to this. For example, the viewer ID may be preliminarily allocated to the respective viewers, and the respective viewers may select the desired time slot through a management screen of the management unit for display time. In this case, an operation of selecting the desired time slot may be performed through an input interface of the management unit for display time, or may be performed through a communication terminal and through an input interface of the communication terminal after an access to the management unit for display time. Moreover, when the terminal for viewing has functions of communication and input, the operation may be performed through the terminal for viewing.

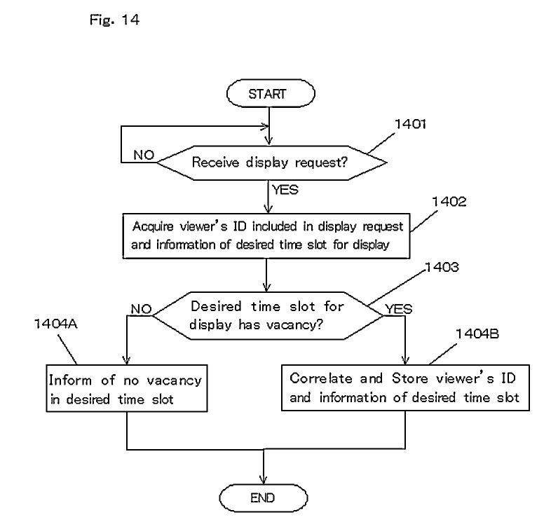

FIG. 14 is a flowchart of the case where a display request for the image reflecting the viewer's motion from the viewer is received. At the outset, in a step S1401, it is determined whether the display request for the image reflecting the viewer's motion has been received from the viewer. If it is determined that the request has been received, the processing shifts to a step S1402, and if not, the processing is in waiting state. Subsequently, in a step S1402, the viewer ID included in the display request and the information of desired time slot for display are acquired. Subsequently, in a step S1403, it is determined whether the desired time slot for display has vacancy. The determination is made on the basis of information of the display time slot, the number of displayable viewers in the time slot, and the number of viewers having made reservation in the time slot etc. Here, if it is determined that the desired time slot has no vacancy, the processing shifts to a step S1404A, and if the time slot has vacancy, the processing shifts to a step S1404B. In the step S1404A, no vacancy in desired time slot is informed to the viewer. In the step S1404B, the viewer ID and the display time slot are correlated and stored, and a completion of the reservation of the display time slot is informed to the viewer. Moreover, increment process of the number of viewers having made reservation in the time slot is executed. It is assumed that the above processing is executed before the start of the live performance etc, and after the start of the live performance, the remaining display time slots during the live performance etc. may be reserved upon receiving the display request for them.

The ‘first acquisition section’ has a function of acquiring the display time information from the management unit for display time information. When the management unit for display time and the display controller exist as different and separate apparatus, the display controller receives the display time information from the management unit for display time through the wired or wireless communication interface, and when they exist as an integrated apparatus, the display time information is received through an internal system bus.

The ‘control section for display according to time’ has a function of controlling display of the image reflecting the motion of the viewer during the display time. Here, it is possible to vary the image reflecting the viewer's motion according to length of the remaining time within the display time. For example, it is possible to increase a transparency of the display element reflecting the viewer's motion according to the length of the remaining time (i.e., the display element fades away), to vary color of the display element, to reduce size of the display element, or to move the display element backward in a virtual space formed on the display.

Moreover, the receiver for motion information may further comprise a third acquisition section, acquiring the display time information from the management unit for display time, and a section for restricted reception, transmitting the motion information during the display time.

Moreover, the management unit for display time may comprise table information, where the viewer ID and retained points of the viewer are correlated (storage section for point table). In this case, a reception section for display request determines whether points above a predetermined level are retained when receiving the display request for the image reflecting the viewer's motion from the viewer. If the required points are still retained, the display request is accepted, points necessary for display are reduced from the retained points, and the table information is updated. If the required points are not retained, a notification to purchase points is sent to the viewer. Moreover, the management unit for display time may comprise table information, where the viewer ID and a credit number of the viewer are correlated (storage section for credit table), thereby smoothly carrying out the purchase of points. The information of the number of credit may be received from the viewer's communication terminal at the registration.

### Concrete Configuration of Third Embodiment

The ‘management unit for display time’ is configured by a CPU, a RAM, a ROM, a long-term memory, a WAN interface, and a LAN interface etc. The ‘management unit for display time’ transmits the display time information of the image reflecting the viewer's motion stored in the long-term memory though the LAN interface in response to the transmission request for the display time information from the ‘display controller’. The ‘display controller’ receives the display time information through the LAN interface, and determines which image reflecting the viewer's motion is to be displayed in which display time slot on the basis of the display time information of the respective viewers. Subsequently, the ‘display controller’ receives the motion information of the viewer to be displayed in the time slot at the respective time slots from the ‘receiver for motion information’ through the LAN interface, and generates the display control information for a large-screen display on the basis of the motion information, and transmits the generated display control information for a large-screen display'. The large-screen display' displays the image on the basis of the received display control information. Note that, in the above example, the ‘management unit for display time’ is separated from the ‘receiver for motion information’ and the ‘display controller’, and these components may be configured as an integrated apparatus by common hardware.

### Processing Flow of Third Embodiment

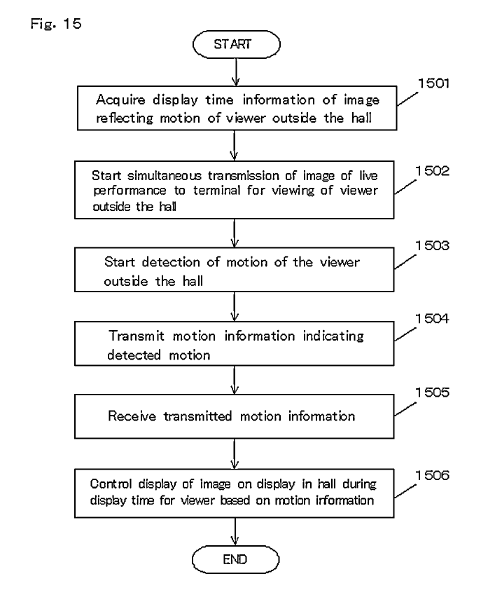

FIG. 15 is a flowchart of an image display method of the image display system of the third embodiment. At the outset, in a step S1501, the display control terminal acquires the display time information of the image reflecting the motion of the viewer outside the hall for the live performance etc. from a management server for display time (step of acquiring display time information). Subsequently, in a step S1502, the live transmitter starts simultaneous transmission of image of live performance to the terminal for viewing of viewer outside the hall in response to a request for viewing from the terminal for viewing (step of starting starts simultaneous transmission). The terminal for viewing receives and displays the image of live performance from the live transmitter. Subsequently, in a step S1503, the motion detector starts detection of motion of the viewer outside the hall (step of starting detection of motion). The motion data detected by the motion detector is, for example, transmitted to the user's communication terminal through the wireless interface. Subsequently, in a step S1504, the user's communication terminal transmits the motion information indicating the detected motion (step of transmitting motion information). Subsequently, in a step S1505, the control-side communication terminal receives the transmitted viewer's motion information (step of receiving motion information). Subsequently, in a step S1506, when the display time of the image reflecting the motion of the viewer outside the hall comes, display of the image on the display in hall is controlled based on the received motion information of the viewer (step of controlling display).

### Effects of Third Embodiment

According to the image display system of the third embodiment, in addition to the effects of the first and second embodiment, it is possible to manage the respective display time for the viewer, thereby appropriately displaying the display element reflecting the motion of the respective viewers without jamming them into the display screen even when a plurality of viewers outside the hall exists.

### Fourth Embodiment

### Outline of Fourth Embodiment

An image display system of a fourth embodiment is basically the same as that of the first and second embodiments, and further has a feature in managing the display time for the image reflecting the motion of the viewer, and transmits the motion information of the viewer outside the hall during the display time.

### Configuration of Fourth Embodiment

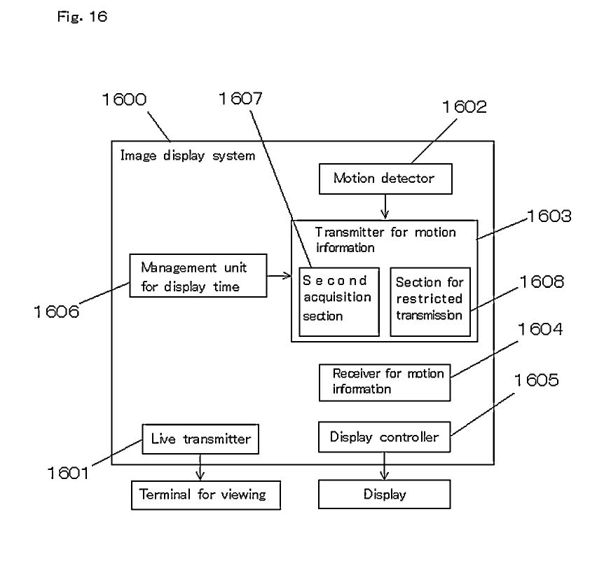

FIG. 16 is a functional block diagram of an image display system of the fourth embodiment. As shown in FIG. 16, an ‘image display system’ 1600 comprises a ‘live transmitter’ 1601, a ‘motion detector’ 1602, a ‘transmitter for motion information’ 1603, a ‘receiver for motion information’ 1604, a ‘display controller’ 1605, and a ‘management unit for display time’ 1206. The ‘transmitter for motion information’ further comprises a ‘second acquisition section’ 1607 and a ‘section for restricted transmission’ 1608. Hereinafter, descriptions of the respective components will be provided.

The ‘management unit for display time’ is the same as that of the third embodiment, and in the image display system of the fourth embodiment, with the transmitter for motion information and the receiver for motion information, a plurality of management units for display time may be provided for the respective viewers and the respective terminals for viewing. In this case, the management unit for display time may be integrated with the transmitter for motion information as an apparatus, or may be connected with the transmitter for motion information through LAN. In this case, the management unit for display time may store only the display time information of restricted viewers, and may not store the display time information of the other viewers. The ‘second acquisition section’ of the transmitter for motion information has a function of acquiring the display time information from the management unit for display time information. The transmitter for motion information receives the display time information from the management unit for display time through the wired or wireless communication interface. When the management unit for display time and the transmitter for display time exist as an integrated apparatus, the display time information is received through an internal system bus.

The ‘section for restricted transmission’ of the transmitter for motion information has a function of transmitting the motion information during the display time. According to this, the receiver for motion information receives only the viewer's motion information within the display time, and does not receive the other viewer's motion information out of the display time. Moreover, it is unnecessary to select the received information on the basis of the viewer ID.

Moreover, in addition to the above configuration, the motion detector may comprise a fourth acquisition, acquiring the display time information from the management unit for display time, and a section for restricted transmission, transmitting the motion information during the display time. In this case, it is possible to reduce extra power consumption in the motion detector and the transmitter for motion information.

### Concrete Configuration of Fourth Embodiment

The ‘management unit for display time’ is configured by a CPU, a RAM, a ROM, a long-term memory, a WAN interface, and a LAN interface etc. The ‘management unit for display time’ transmits the display time information of the image reflecting the viewer's motion stored in the long-term memory to the ‘transmitter for motion information’ though the LAN interface or the WAN interface in response to the transmission request for the display time information from the ‘transmitter for motion information’. The ‘display controller’ receives the display time information through the LAN interface or the WAN interface, and determines the display time slot where the motion information is transmitted on the basis of the display time information of the viewer. Subsequently, the ‘transmitter for motion information’ transmits the motion information of the viewer to the ‘receiver for motion information’ at a predetermined time slot through the WAN interface.

The ‘receiver for motion information’ receives the motion information through the WAN interface, and generates the display control information for a large-screen display on the basis of the motion information, and transmits the generated display control information for a large-screen display'. The ‘large-screen display’ displays the image on the basis of the received display control information. Note that, in the above example, the ‘management unit for display time’ is separated from the ‘receiver for motion information’, and these components may be configured as an integrated apparatus by common hardware.

### Processing Flow of Fourth Embodiment

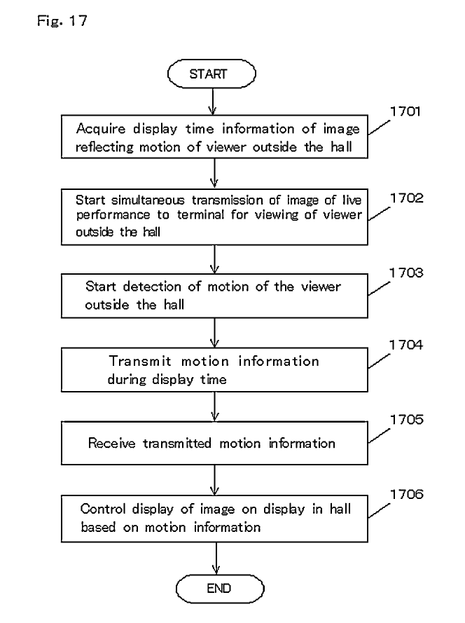

FIG. 17 is a flowchart of an image display method of the fourth embodiment. At the outset, in a step S1701, the display control terminal acquires the display time information of the image reflecting the motion of the viewer outside the hall for the live performance etc. from a management server for display time. Subsequently, in a step S1702, the live transmitter starts simultaneous transmission of image of live performance to the terminal for viewing of viewer outside the hall in response to a request for viewing from the terminal for viewing. Subsequently, in a step S1703, the motion detector starts detection of motion of the viewer outside the hall. The motion data detected by the motion detector is, for example, transmitted to the user's communication terminal through the wireless interface. Subsequently, in a step S1704, the user's communication terminal transmits the motion information indicating the viewer's motion at the display time for the image reflecting the viewer's motion. Subsequently, in a step S1705, the control-side communication terminal receives the transmitted viewer's motion information. The motion information received by the control-side communication terminal is, for example, transmitted to the display control terminal through the LAN interface. Subsequently, in a step S1706, when the display time of the image reflecting the motion of the viewer outside the hall comes, display of the image on the display in hall is controlled based on the received motion information of the viewer.

### Effects of Fourth Embodiment

According to the image display system of the fourth embodiment, in addition to the effects of the first and second embodiment, it is possible to receive only motion information of the viewer within the display time, and to not receive the other motion information of the viewer out of the display time, thereby reducing processing load of the relevant apparatuses.

### Fifth Embodiment

### Outline of Fifth Embodiment

An image display system of a fifth embodiment is basically the same as that of the third and fourth embodiments, and further has a feature in accepting an extension request for the display time for the image reflecting the viewer's motion outside the hall, and in extending the display time according to the extension request.

### Configuration of Fifth Embodiment

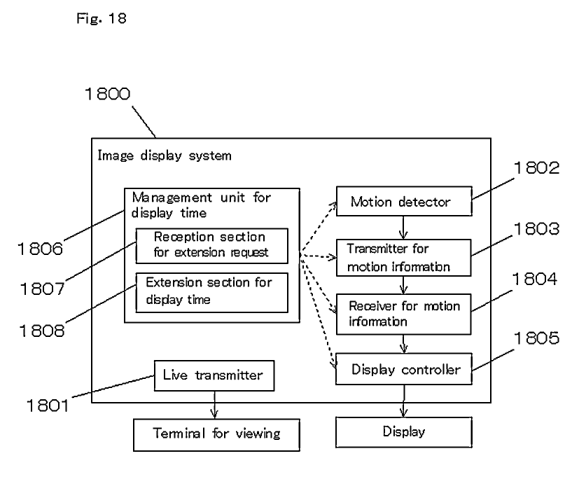

FIG. 18 is a functional block diagram of an image display system of the fifth embodiment. As shown in FIG. 18, an ‘image display system’ 1800 comprises a ‘live transmitter’ 1801, a ‘motion detector’ 1802, a ‘transmitter for motion information’ 1803, a ‘receiver for motion information’ 1804, a ‘display controller’ 1805, and a ‘management unit for display time’ 1806. The ‘management unit for display time’ further comprises an ‘acceptance section for extension request’ 1807 and an ‘extension section for display time’ 1808.

Although not shown diagrammatically, as described in the third embodiment, the ‘display controller’ may further comprise the ‘first acquisition section’ and the ‘control section for display according to time’, and the ‘receiver for motion information’ may further comprise the ‘third acquisition section’ and the ‘section for restricted reception’. Moreover, as described in the fourth embodiment, the ‘transmitter for motion information’ may comprise the ‘second acquisition section’ and the ‘section for restricted transmission’, and the ‘motion detector’ may comprise a ‘fourth acquisition section’ and a ‘section for restricted detection’. In any of the above configurations, the display time information is used, thereby appropriately displaying the display element reflecting the motion of the respective viewers without jamming them into the display screen even when a plurality of viewers outside the hall exist.

The ‘acceptance section for extension request’ of the management unit for display time has a function of accepting an extension request for the display time. The extension request for the display time is a request for extending the display time for the image reflecting the viewer's motion. The extension request for the display time may be accepted through the management screen of the management unit for display time, and the extension request may be included in the motion information.

Specifically, the motion detector may further comprise a motion detection section for extension request, detecting the motion as a target for the request for extending the display time, the transmitter for motion information may further comprise a transmission section for motion information for extension request, transmitting motion information for extension request, which is information of the motion as the target for the request for extending the display time, and the reception section for extension request of the management unit for display time may receive the motion information for extension request transmitted from the transmitter for motion information, thereby accepting the extension request. According to this configuration, without accessing to the management screen and inputting thereto, the viewer can request the extension of the display time by his own operation. For example, when the viewer makes a predetermined number of motions of swinging his arm around, the motion may be detected, and transmitted as the motion information for extension request.

The ‘extension section for display time’ of the management unit for display time has a function of extending the display time according to the acceptance of the extension request. The extending the display time according to the acceptance of the extension request is extension of the display time for the image reflecting the motion of the viewer outside the hall subject to the acceptance of the extension request for the display time.

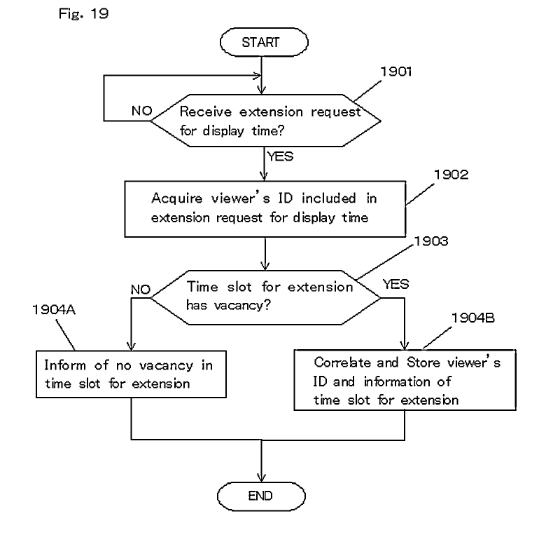

Note that the all extension requests for the display time are not always accepted, and may be accepted in the case that it is determined that the extension of the display time is possible. FIG. 19 is a flowchart of the case where an extension request from the viewer is received. At the outset, in a step S1901, it is determined whether the extension request for the image reflecting the viewer's motion has been received from the viewer. If it is determined that the extension request has been received, the processing shifts to a step S1902, and if not, the processing is in waiting state. Subsequently, in a step S1902, the viewer ID included in the extension request is acquired. Subsequently, in a step S1903, it is determined whether the extension time slot for extension has vacancy. The determination is made on the basis of information of the display time slot, the number of displayable viewers in the extension time slot, and the number of viewers having made reservation in the time slot etc. Here, if it is determined that the extension time slot has no vacancy, the processing shifts to a step S1904A, and if the extension time slot has vacancy, the processing shifts to a step S1904B. In the step S1904A, no vacancy in the extension time slot is informed to the viewer. In the step S1904B, the viewer ID and the extension time slot are correlated and stored, and the extension of the display time is informed to the viewer. Moreover, an increment process of the number of viewers having made reservation in the extension time slot is executed.

Moreover, the management unit for display time may comprise table information, where the viewer ID and retained points of the viewer are correlated. In this case, the acceptance section for extension request determines whether points above a predetermined level are retained when receiving the extension request for the display time. If the required points are still retained, the extension request is accepted, points necessary for display are reduced from the retained points, and the table information is updated. If the required points are not retained, a notification to purchase points is sent to the viewer.

### Concrete Configuration of Fifth Embodiment

The ‘management unit for display time’ is configured by a CPU, a RAM, a ROM, a long-term memory, a WAN interface, and a LAN interface etc. The ‘management unit for display time’ receives the extension request for the display time for the image reflecting the viewer's motion through the WAN interface, and determines whether the extension of the display time is possible. Moreover, the management unit transmits a notification as to whether the extension of the display time is possible to the viewer's communication terminal through the WAN interface. If extension of the display time is possible is possible, an update of the display time is executed, such that the display time for the image reflecting the viewer's motion stored in the long-term memory is extended. The updated display time information is transmitted to the ‘display controller’ through the LAN interface. The ‘display controller’ receives the updated display time information through the LAN interface, and further determines which image reflecting the viewer's motion is to be displayed in which display time slot on the basis of the display time information of the respective viewers. The other processes are the same as those described in the first to fourth embodiments.

### Processing Flow of Fifth Embodiment

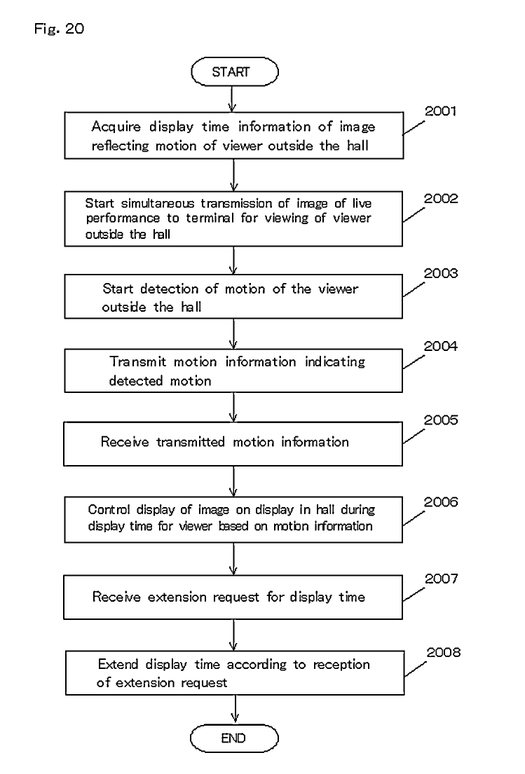

FIG. 20 is a flowchart of an image display method of the fifth embodiment. At the outset, in a step S2001, the display control terminal acquires the display time information of the image reflecting the motion of the viewer outside the hall for the live performance etc. from a management server for display time (step of acquiring display time information). Subsequently, in a step S2002, the live transmitter starts simultaneous transmission of image of live performance to the terminal for viewing of viewer outside the hall in response to a request for viewing from the terminal for viewing (step of starting starts simultaneous transmission). Subsequently, in a step S2003, the motion detector starts detection of motion of the viewer outside the hall (step of starting detection of motion). The motion data detected by the motion detector is, for example, transmitted to the user's communication terminal through the wireless interface. Subsequently, in a step S2004, the user's communication terminal transmits the motion information indicating the detected motion (step of transmitting motion information). Subsequently, in a step S2005, the control-side communication terminal receives the transmitted viewer's motion information (step of receiving motion information). Here, the motion information received by the control-side communication terminal is, for example, transmitted to the display control terminal through the LAN interface. Subsequently, in a step S2006, when the display time of the image reflecting the motion of the viewer outside the hall comes, the display control terminal controls display of the image on the display in hall based on the received motion information of the viewer (step of controlling display). Subsequently, in a step S2007, the management server for display time accepts the extension request for display time (step of accepting extension request). Subsequently, in a step S2008, the management server for display time extends the display time in response to the acceptance of the extension request for display time (step of extending display time)

### Effects of Fifth Embodiment

According to the image display system of the fifth embodiment, in addition to the effects of the third and fourth embodiments, it is possible to extend the display time for the image reflecting the viewer's motion as necessary.

### DESCRIPTION OF REFERENCE NUMERALS

0100, 1000, 1200, 1600 and 1800 Image display system
0101,1001,1201,1601 and 1801 Live transmitter
0102, 1002, 1202, 1602 and 1802 Motion detector
0103, 1003, 1203, 1603 and 1803 Transmitter for motion information
0104, 1004, 1204, 1604 and 1804 Receiver for motion information
0105, 1005, 1205, 1605 and 1805 Display controller
1206, 1606 and 1806 Management unit for display time
1006 Detection section for swinging motion
1207 First acquisition section
1208 Control section for display according to time
1607 Second acquisition section
1608 Section for restricted transmission
1807 Acceptance section for extension request
1808 Extension section for display time

1. An image display system for displaying an image reflecting a motion of a viewer outside a hall for live performance on a display in the hall, the system comprising:
a live transmitter, simultaneously transmitting the image of the live performance in the hall to a terminal of the viewer;
a motion detector, detecting the motion of the viewer outside the hall;
a transmitter for motion information, transmitting motion information for indicating the motion detected by the motion detector;
a receiver for motion information, receiving the motion information transmitted by the transmitter for motion information; and
a display controller, controlling display of the image on the display having been installed in the hall on a basis of the received motion information.

2. The image display system according to claim 1,
wherein the motion detector further comprises a detection section for swinging motion, detecting swinging motion of the viewer outside the hall.

3. The image display system according to claim 1,
wherein the display controller further comprises a display control section for avatar, controlling display of an image including an avatar on a basis of the motion information.

4. The image display system according to claim 2,
wherein the display controller further comprises a control section for displaying swinging motion, controlling display of an image including a swinging object showing the same motion as the swinging motion of the viewer.

5. The image display system according to claim 4,
wherein the swinging object is a concert light.

6. The image display system according to claim 1, further comprising:
a management unit for display time, managing display time information of the image reflecting the motion of the viewer,
wherein the display controller further comprises
a first acquisition section, acquiring the display time information from the management unit for display time information, and
a control section for display according to time, controlling display of the image reflecting the motion of the viewer during the display time.

7. The image display system according to claim 1, further comprising:
a management unit for display time, managing display time information of the image reflecting the motion of the viewer,
wherein the transmitter for motion information further comprises
a second acquisition section, acquiring the display time information from the management unit for display time information, and
a section for restricted transmission, transmitting the motion information during the display time.

8. The image display system according to claim 1,
wherein the management unit for display time further comprises,
an acceptance section for extension request, accepting an extension request for the display time, and
an extension section for display time, extending the display time according to the acceptance of the extension request.

9. A method for displaying an image reflecting a motion of a viewer outside a hall for live performance on a display in the hall, the method comprising:
starting simultaneous transmission of an image of the live performance in the hall to a terminal of the viewer outside the hall;
starting detection of a motion of the viewer outside the hall;
transmitting motion information indicating the detected motion;
receiving the transmitted motion information; and
starting control of displaying the image on the display having been installed in the hall on a basis of the received motion information.

10. A computer-readable storage medium storing a program for causing a computer to execute a process of displaying an image reflecting a motion of a viewer outside a hall for live performance on a display in the hall, the program comprising:
receiving motion information indicating a motion of the viewer outside the hall from a transmission source;
controlling display of the image on the display having been installed in the hall on a basis of the received motion information.

11. A computer-readable storage medium storing a program for causing a computer to execute a process of displaying an image reflecting a motion of a viewer outside a hall for live performance on a display in the hall, the program comprising:
starting detection of a motion of the viewer outside the hall; and
transmitting motion information indicating the detected motion to a terminal for controlling display of the image on the display having been installed in the hall.
